(19) United States
(12) Patent Application Publication
(10) Pub. No.: US 2005/0055647 A1
(43) Pub. Date: Mar. 10, 2005

(54) System and method for switching software functions

(76) Inventor: Chung-Hui Chen, Taipei (TW)

Correspondence Address: BIRCH STEWART KOLASCH & BIRCH, PO BOX 747, FALLS CHURCH, VA, 22040-0747, US

(21) Appl. No.: 10/812,873

(22) Filed: Mar. 31, 2004

Related U.S. Application Data
(60) Provisional application No. 60/500,341, filed on Sep. 5, 2003.

(51) Int. Cl. G09G 5/00

(52) U.S. Cl. 715/827; 715/747; 715/811; 715/789; 715/745; 715/773; 715/778; 715/718; 715/841

(57) ABSTRACT

A software function switching method and a system using the same that allows the user to set and operate a group of keys in an input unit as the hotkey sequence for switching and opening the sub-menu functions of application software. The user only needs to repeatedly press the first key of the hotkey sequence, and then intermittently press the second key of the hotkey sequence to send the input signals via the input unit into a data processing system. This method and system instructs the data processing system to count the number of times the user has pressed the hotkey, and, according to the count value, diagrams on the display unit corresponding to the sub-menu functions of the application software are sequentially switched and opened. When switched to the diagram for the sub-menu function that the user wishes to open, the first key of the hotkey is released, and the sub-menu function represented by the diagram can be opened. This allows the user to sequentially switch to and open every sub-menu function of the application software using only a set of hotkeys.

### FIELD OF THE INVENTION

The present invention relates to a method for switching software functions and a system using the same. More specifically, it relates to a method that enables sequential switching and opening of sub-menu functions of application software by employing a set of combination keys and a system using the same.

### DESCRIPTION OF THE PRIOR ART

Owing to the continuous development in the electronic information industry, various inexpensive and powerful consumer electronic information products, such as the desktop computer (PC), notebook computers, and Personal Digital Assistant (PDA) have emerged. In particular, the personal computer (PC) has transformed from an information product to a home appliance. In other words, people rely not only on its binary calculation performance, but also on capabilities that are not achievable by other home appliances. Therefore, diverse application software with great functionality has emerged to provide convenient services to people.

Most of the application software nowadays integrates a variety of functions, and provides menus and sub-menus for each function, so that users can click and open the functions provided by the application software either via a mouse or via a keyboard. Application software usually provide users with hotkeys that define the activation of various functions of the application software in order to open the functions of the application software more conveniently. However, for application software having several or tens of sub-functions, most users do not memorize all the hotkeys defining the various sub-functions. Alternatively, it may be the case that the application doesn't provide hotkey sequences for all sub-functions. Moreover, if one application takes up several sets of button definitions for its sub-functions, then, when several applications are opened, problem emerge. Not only are the keys on the keyboard that can correspond to the sub-functions of the application software limited, but also users may easily get confused as to which sub-function the combination of keys correspond to, creating more usage confusion and inconvenience.

### SUMMARY OF THE INVENTION

According to the problems of the prior art, a primary objective of the present invention is to provide users with a method for switching application software and a system using the same, so that users can quickly open the sub-menu functions of an application program by memorizing only one set of combination keys. This eliminates the need to individually memorize a combination of keys corresponding to each of the sub-menu functions of the application software when switching or opening them in the traditional way, increasing convenience and avoiding confusion.

In order to achieve the above objective, the software function switching system of present invention comprises: an input unit that allows a group of keyswhich is configurable and operable by the user to be used as a hotkey combination for an application program to enable the sequential switching and opening of the sub-menu functions of the application program; a display unit that shows representing diagrams of the sub-menu functions being switched to or opened by the user through the hotkey combination; and a data processing system that is used to receive and process the signals sent from the input unit operated by the user, and, based on the input signals, perform switching and opening of the sub-menu functions of the application program.

The method of software function switching method using the software function switching system comprises: the user setting a plurality of keys on the input unit to correspond to the hotkeys of an application program, in order to switch or open the various sub-menu functions of the application software. Then, when a hotkey combination of the input unit being pressed, the data processing system receiving the input signal generated by the hotkeys pressed by the user, wherein, afterwards, the user only needs to repeatedly press the first key of the hotkey combination, and then intermittently press the second key of the hotkey combination to sequentially switch the representing diagrams of sub-menu functions of the application software shown on the display unit until switching to the representing diagram of the sub-menu function desired to be opened, whereupon the first key of the hotkey combination is released to open the sub-menu function represented by the diagram.

Using the software function switching method and system of the present invention, users can quickly switch to and open the various sub-menu functions of an application program using a set of hotkeys, which effectively avoids the problem of memorizing and setting the corresponding hotkeys to different sub-menus functions for various applications in order to switch to or open the sub-menu functions.

### BRIEF DESCRIPTION OF THE DRAWINGS

The preferred embodiments are illustrated in accordance with the accompanied diagrams to further illustrate the features and functions of the present invention.

FIG. 1 is a system block diagram showing the basic structure of the software function switching system according to an embodiment of the present invention;

FIG. 2 is an application diagram showing the operating diagram of the software function switching according to an embodiment of the present invention; and

FIG. 3 is a flowchart showing the steps of the software function switching method according to an embodiment of the present invention.

### DETAILED DESCRIPTION OF THE PREFFERED EMBODIMENT

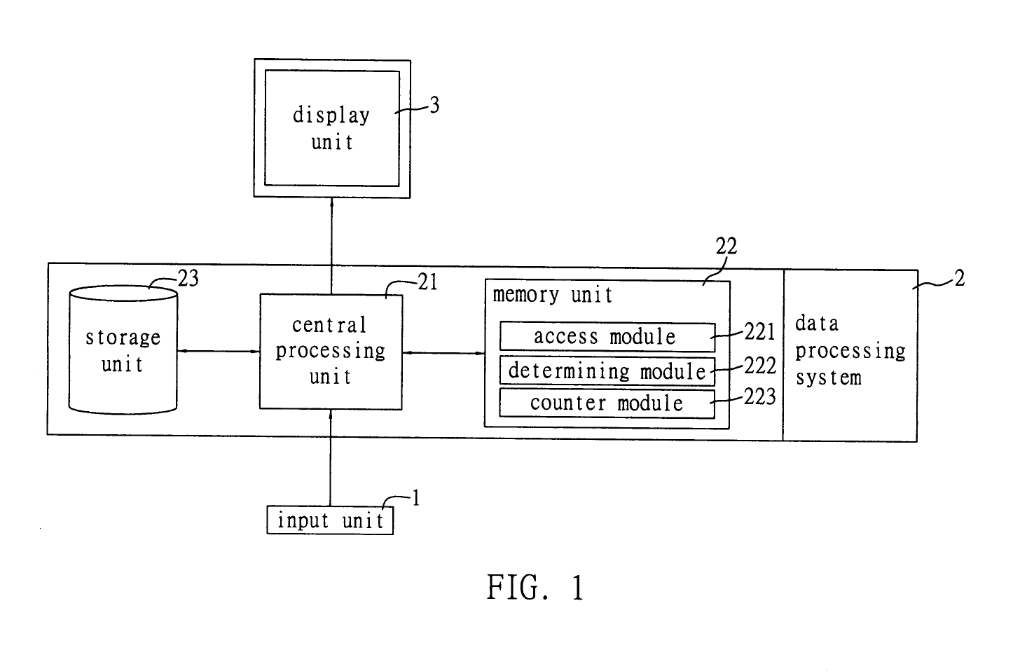

Referring to FIG. 1 which shows the basic structure of the software function switching system of the present invention, the software function switching system comprises an input unit 1, a display unit 3, and a data processing system 2.

The input unit 1 enables a user to set and operate a group of keys therein as a hotkey sequence for opening an application program. Users actuate the hotkey sequence using the input unit 1 to quickly switch to and open the sub-menu functions of the application program. In this embodiment, the input unit 1 is a keyboard of a personal computer.

The display unit 3 is used to show the image when a user switches or opens the representing diagram of the sub-menu function of the application program via the hotkey. In this embodiment, the display unit 3 is a monitor of a personal computer.

The data processing system 2 is used to receive each input signal sent when the user operates the hotkey via the input unit 1 in order to perform the switching and opening of the sub-menu functions of the application program according to the operating needs of the user. In this embodiment, the data processing system 2 is a personal computer.

The data processing system 2 comprises a central processing unit 21, a storage unit 23, and a memory unit 22. The central processing unit 21 is used to drive the units and modules of the data processing system 2 and execute switching and opening of the sub-menu functions of the application software; the storage unit 23 is used to store the application-software-related information; the memory unit 22 is used to access, determine, and count the input signals generated when a user switches to open the sub-menu functions of the application program by operating the hotkey. Inside the storage unit 22, there is an accessing module 221 used to access the input signals generated when a user operates the input unit 1, a determining module 222 used to determine whether the input signal matches the hotkey function previously set by the user, and a counter module 223 used to count the number of times input signals are generated upon a user operating the hotkey via the input unit 1. In this embodiment, the storage unit 23 is a hard disk and the memory unit 22 is any one of Dynamic Random Access Memory (DRAM) or Static Random Access Memory (SRAM).

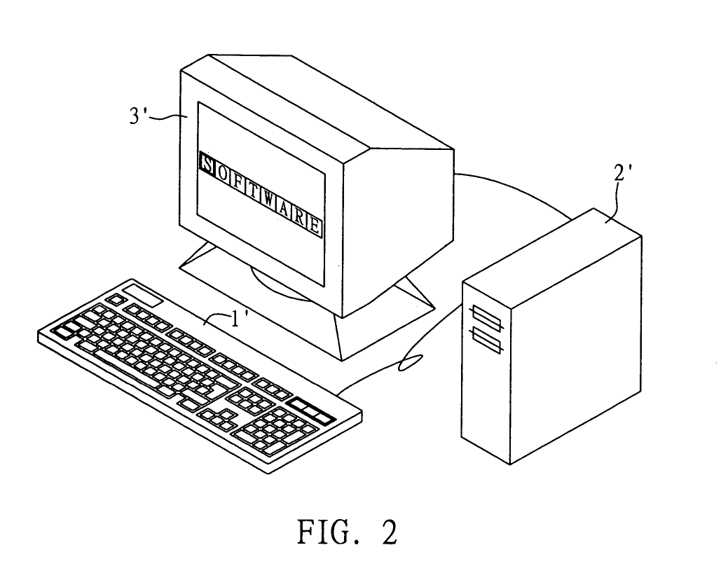

Referring to FIG. 1 and FIG. 2 which show the operating diagrams of the software switching function of the present invention, firstly the user sets a set of combination keys on an input unit such as a keyboard 1′ as the hotkey for switching and opening the sub-menu functions of the application program. For example, the user might set the Alt-key in combination with the A key as the hotkey for switching and opening of the sub-menu of the application program. When a user simultaneously presses the Alt-key and the A key on the keyboard 1′, and keeps pressing the the Alt-key and then releases A key, the keyboard 1′ sends the input signal generated by the user to the central processing unit 21 of the personal computer 2′. Then the central processing unit 21 drives the access module 221 and the determining module 222 respectively to perform accessing of the input signal, and then determination of whether the input signal generated matches the hotkey. If not, the central processing unit 21 stops generating action for this input signal. If yes, the central processing unit 21 drives the counter module 223 within the memory unit 22. The input signal generated by simultaneously pressing the Alt-key in combination with the A key and then holding the Alt-key while releasing A key is initially counted as one. At the same time, the central processing unit 21 sends this first input signal to the display unit such as a personal computer monitor 3′ such that a cursor pointing to the representing diagram S of the first sub-menu function of the application program appears on the display of the personal computer monitor 3′. Then, if the user presses the Alt-key and presses and releases the A key, this generates a second input signal and the counter module 223 counts to two, which triggers the cursor to point to the second representing diagram O of the second sub-function of the application program on the monitor 3′.

Similarly, the user only needs to continue pressing the Alt-key, then, intermittently pressing and releasing the A key to keep sending input signals to the personal computer 2′ to cause the cursor of computer monitor 3′ to sequentially switch to the next sub-menu function diagram based on the increase of the count of the counter module 223. When the cursor moves to the last representing diagram E of the sub-menu functions of the application program, if the user presses the hotkey again, then the cursor switches to the next diagram, and switches back to the first diagram S, until the cursor switches to the representing diagram of the sub-menu function that the user wishes to open, whereupon, releasing the Alt-key completes switching of sub-menu functions of the application program, ending the series of input signals. At this time, the central processing unit 21 then opens the sub-menu functions stored in the memory unit 23 according to the representing diagram of sub-menu functions of the application program being displayed on the monitor 3′ switched to by the cursor and corresponding to the last count of the counter module 223. The function that is opened is further displayed on the monitor 3′ to allow the user to access the function.

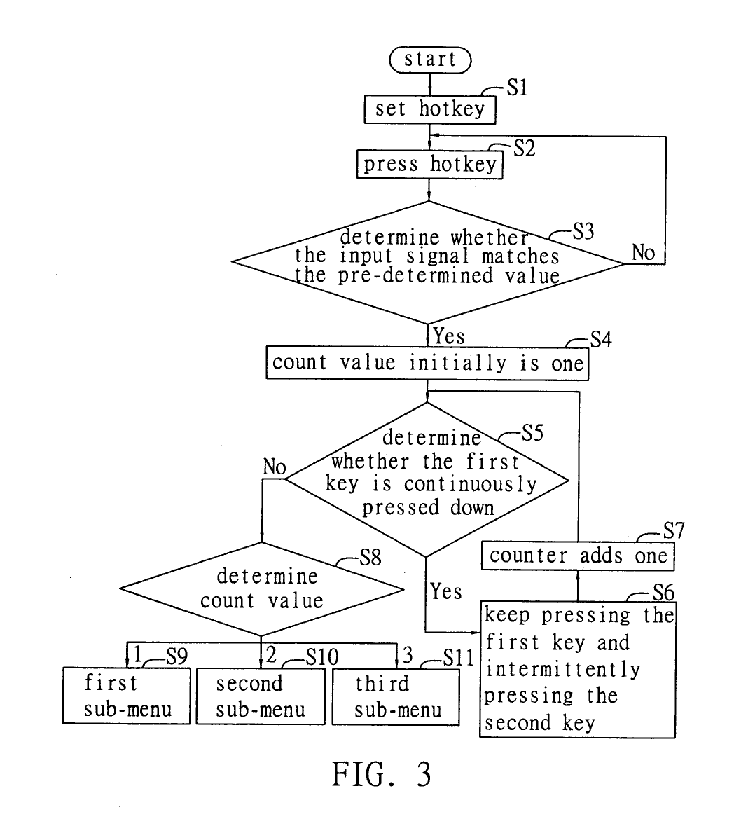

FIG. 3 shows the flowchart depicting the steps of the software function switching method according to the present invention.

Firstly, perform step S1 by setting a group of keys on the input unit 1 as the hotkey for switching and opening the sub-menu functions for an application program with three sub-menu function diagrams, then perform step S2.

In step S2, perform the switching and opening of the sub-menu functions of the application program is performed by pressing the hotkey of the input unit 1, and, at the same time, the input unit 1 sends the input signal generated when the user presses the hotkey to the data processing system 2, then carry out step S3.

In step S3, the central processing unit 21 of the data processing system 2 drives the access module 221 and the determining module 222 respectively to access and determine whether the input signals of the hotkey matches the pre-determined value, if so, continue to step S4, else return to S2.

In step S4, according to the first time the user presses a hotkey, the counter module 223 of the memory unit 22 increments to one in accordance with the input signals, and, at the same time, the indicating cursor on the display unit 3 then points to the representing diagram of the first sub-menu of the application program, then move to step S5.

In step S5, determine whether the user is continuously pressing the first key of the hotkey, if so, perform step S6, or else perform S5.

In step S6, the user again presses the first key of the hotkey, and then presses the second key of the hotkey and releases it, which again generates an input signal into the data processing system 2, then carry out step S7.

In step S7, the counter module 223 adds one to its counting values in accordance with the input signal received, and, at the same time, the cursor moves to the next representing diagram of the sub-menu functions of the application program on the display unit 3, then return to step S5.

In step S8, since the user no longer presses the hotkey, terminating the input signal, the final count values accumulated by the counter module 223 is sent to the central processing unit 21, whereupon, step S9, step S10, or step S11 is performed according to the count values of the counter module 223.

In step S9, in that the count value of counter module 223 is one, the central processing unit 21 opens the first sub-menu function of the application program stored in the storage unit 23, and displays it on the display unit 3.

In step S10, in that the count value of counter module 223 is two, the central processing unit 21 opens the second sub-menu function of the application program stored in the storage unit 23, and displays it on the display unit 3.

In step S11, in that the count value of counter module 223 is three, the central processing unit 21 opens the third sub-menu function of the application program stored in the storage unit 23, and displays it on the display unit 3.

Similarly, if the count value of the counter module is four, the central processing unit opens the fourth sub-menu function, if the count value of the counter module is five, the central processing unit opens the fifth sub-menu function, if the count value of the counter module is six, the central processing unit opens the sixth sub-menu function. Based on this order, the user only needs to set and memorize one combination of keys in order to sequentially switch and open every sub-menu function of the application program.

The foregoing descriptions of specific embodiments are only to illustrate the present invention. They are not intended to limit the scope of the technical content of the present invention in any way. The scope of the invention is defined by the Claims appended hereto; any technical implementations or methods achieved by others skilled in the art that are equivalent to those defined in the following Claims are considered to fall within the scope of the Claims.

1. A method for switching software functions that enables a user to sequentially switch and open a sub-menu function of an application software through a hotkey set by choosing a group of keys on an input unit as the hotkey set, the method comprising the steps of:
1) setting a combination of keys as the hotkey set on the input unit to switch and open various sub-menu functions;
2) repeatedly pressing a first key of the combination of keys and then intermittently pressing a second key of the combination of keys to generate and send input signals to a data processing system;
3) instructing the data processing system to count to obtain a count value the number of times the user has pressed the combination of keys, and, according to the count value, sequentially switching representing diagrams on a display unit for the sub-menu functions of the application program accordingly, and upon reaching the diagram of the sub-menu function that the user wishes to open, releasing the first key of the combination of keys to open the sub-menu function represented by the diagram.

2. The method as claimed in claim 1, wherein the data processing system comprises:
a central processing unit used to drive units and modules within the data processing system for performing the switching and opening of sub-menu functions of the application program;
a storage unit used to store the information related to the application program; and
a memory unit used to access, determine, and count the input signals generated by the user via the input unit.

3. The method as claimed in claim 2, wherein the memory unit comprises:
an accessing module used to access each input signal generated when the user operates the input unit;
a determining module used to determine whether the input signal matches the hotkey signal set previously by the user; and
a counter module used to count number of times the user actuates the hotkey via the input unit, in order to switch to and open the representing diagrams of the sub-menu functions of the application program on the display unit according to the count value.

4. The method as claimed in claim 1, wherein the input unit is a keyboard.

5. The method as claimed in claim 2, wherein the memory unit is either one of a dynamic random access memory (DRAM) or static random access memory (SRAM).

6. A system for switching software functions used to enable a user to sequentially switch to and open sub-menu functions of an application program by a set of hotkeys, the system comprising:
an input unit, wherein a set of keys is provided to the user to set and operate as the hotkeys for the application program, in order to sequentially switch or open various sub-menu functions of the application program;
a display unit used to display the switching and opening of the representing diagrams for the sub-menu functions of the application program through the hotkey operated by the user; and
a data processing system used to receive and count number of times the input signals are generated upon the user actuating the hotkey for a particular program via the input unit, and to perform the switching and opening of the sub-menu functions of the application program.

7. The system as claimed in claim 6, wherein the data processing system comprises:
a central processing unit used to drive units and modules within the data processing system for performing the switching and opening of sub-menu functions of the application program;
a storage unit used to store the information related to the application program; and
a memory unit used to access, determine, and count the input signals generated when the user actuates hotkeys via the input unit.

8. The system as claimed in claim 7, wherein the memory unit comprises:
an accessing module used to access each of the input signals generated when the user operates the input unit;
a determining module used to determine whether the input signal matches the hotkey signal previously set by the user; and
a counter module used to count the number of times the user actuates the hotkey via the input unit to obtain a count value, in order to switch to and open the representing diagrams of the sub-menu functions of the application program on the display unit according to the count value.

9. The method as claimed in claim 6, wherein the input unit is a keyboard.

10. The method as claimed in claim 7 or claim 8, wherein the memory unit is either one of a dynamic random access memory (DRAM) or static random access memory (SRAM).
